(19) United States
(12) Patent Application Publication
(10) Pub. No.: US 2025/0091620 A1
(43) Pub. Date: Mar. 20, 2025

(54) PREDICTION OF MOVABILITY OF AN UNCLASSIFIED OBJECT

(71) Applicant: GM Cruise Holdings LLC, San Francisco, CA (US)

(72) Inventor: Paul Carrington Foster, Mountain View, CA (US)

(21) Appl. No.: 18/468,509

(22) Filed: Sep. 15, 2023

(51) Int. Cl. B60W 60/00; B60W 50/00; G06V 10/26; G06V 10/82; G06V 20/56

(52) U.S. Cl. CPC B60W 60/00274; B60W 50/0097; G06V 10/26; G06V 10/82; G06V 20/56; B60W 2420/403; B60W 2554/4045

(57) ABSTRACT

Systems and techniques are provided for predicting a movability of an unclassified object. An example process includes receiving sensor data captured within a single frame, identifying an unclassified object in the sensor data, and providing the sensor data to a neural network, which is configured to predict a motion signal for the unclassified object in the scene. The example process can further include determining whether the unclassified object is a static object or a dynamic object based on the motion signal.

### BACKGROUND

### 1. Technical Field

The present disclosure generally relates to a perception system. For example, aspects of the present disclosure relate to techniques and systems for predicting a movability of an unclassified object.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements for operations such as perception, planning, control, prediction, etc.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 is a diagram illustrating an example system for predicting a movability of an unclassified object, according to some examples of the present disclosure;

FIG. 3 is a diagram illustrating an example pipeline of training a neural network to predict a movability of an unclassified object, according to some examples of the present disclosure;

FIG. 4 is a flowchart illustrating an example process for predicting a movability of an unclassified object, according to some examples of the present disclosure;

FIG. 5 is a diagram illustrating an example configuration of a neural network model that can be used to implement a perception stack for predicting a movability of an unclassified object, according to some examples of the present disclosure; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously described, sensors are commonly integrated into a wide array of systems and electronic devices. AVs can use the sensors to collect sensor data that the AVs can use for operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc.

An image sensor can be used to obtain sensor data that measures, describes, and/or depicts one or more aspects of a target such as an object. A perception system of an AV may analyze the sensor data to detect and recognize various objects in the surrounding environment of the AV. Some perception systems process the sensor data to represent the objects in a meaningful way, that is, use multiple classifiers, each specialized for different object categories (e.g., pedestrians, vehicles, traffic signs, etc.). For example, a perception system (e.g., a classifier) classifies a detected object into a fitting object class and determines whether to track the detected object based on the object class. However, some detections can be associated with unusual or unconventional objects that cannot be easily classified into a specific category, for example, due to unique characteristics or context. Consequently, misclassification or a failure to classify into a specific category can impact the AV's safety, decision-making, and overall performance, especially if the object is moving or is likely to move.

Systems, apparatuses, processes (also referred to as methods), and computer-readable media (collectively referred to as “systems and techniques” or “system”) are described herein for predicting a movability of an unclassified object. For example, the systems and techniques can determine whether an object is moving or may move (e.g., is likely to move) based on sensor data that is captured within a single frame (e.g., without a motion signal). In some examples, the systems and techniques can provide raw sensor data captured within a single frame to a machine learning model, which is trained to determine a movability of an unclassified object (e.g., whether the unclassified object is predicted to move in the scene).

In some examples, a machine learning model of the disclosed technology can predict a movability of an unclassified object based on sensor data captured within a single frame without a motion signal. As follows, the systems and techniques described herein can determine whether an unclassified object may move so that an autonomous vehicle can predict a future path of the unclassified object and plan a route and/or navigate accordingly. For example, if the unclassified object is predicted to move in the scene, the systems and techniques can provide the information associated with the unclassified object to a tracker and/or a prediction stack for tracking and/or prediction of a path of the unclassified object.

In some instances, a machine learning model of the disclosed technology can be trained by providing sensor data with time-based information to a first neural network and providing sensor data captured in a single frame to a second neural network. An output of the first neural network, which may include a motion signal can be correlated with an output of the second neural network, which may include an unclassified object to train the machine learning model.

Aspects of the disclosed technology can improve object detection and predictions. Without necessarily identifying the type of an object or having to classify an object into a fixed list of object classes, the systems and technologies described herein can determine a movability of an object (e.g., whether an object in the scene may move) so that the movable object can be tracked in the scene. Also, the systems and technologies can determine whether an object may move in the scene based on sensor data captured within a single frame (e.g., a still image) without time-based information.

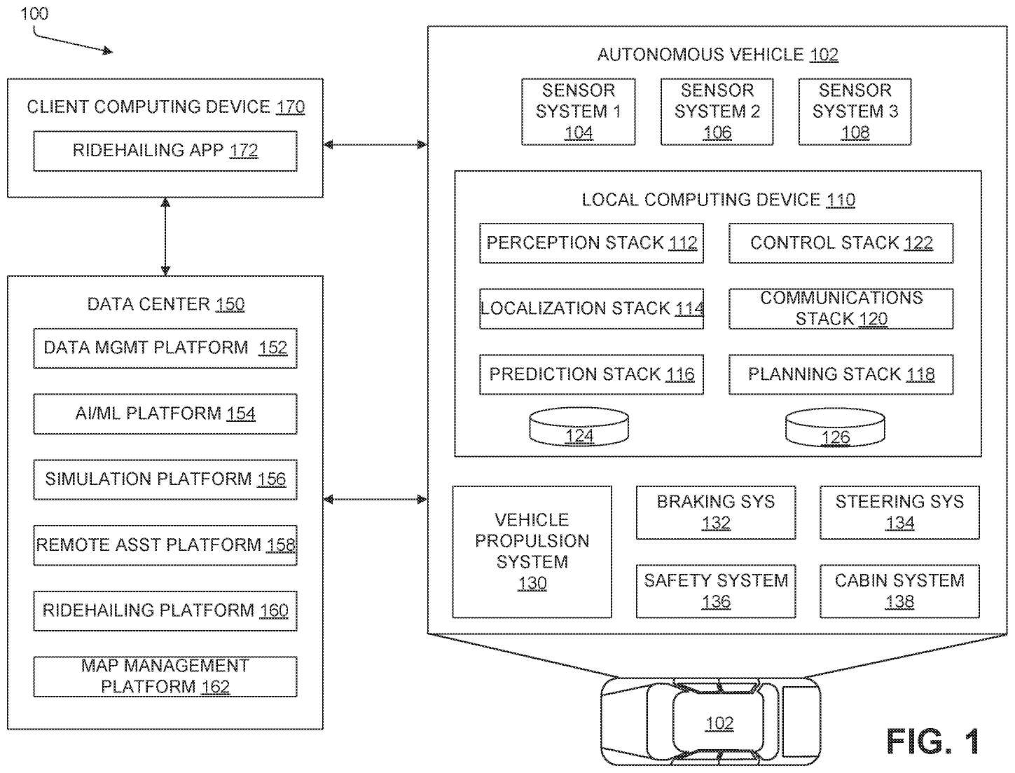

Various examples of the systems and techniques for predicting a movability of an unclassified object are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 (e.g., client application) to enable passengers to view the AV 102 in transit en route to a pick-up or drop-off location, and so on.

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

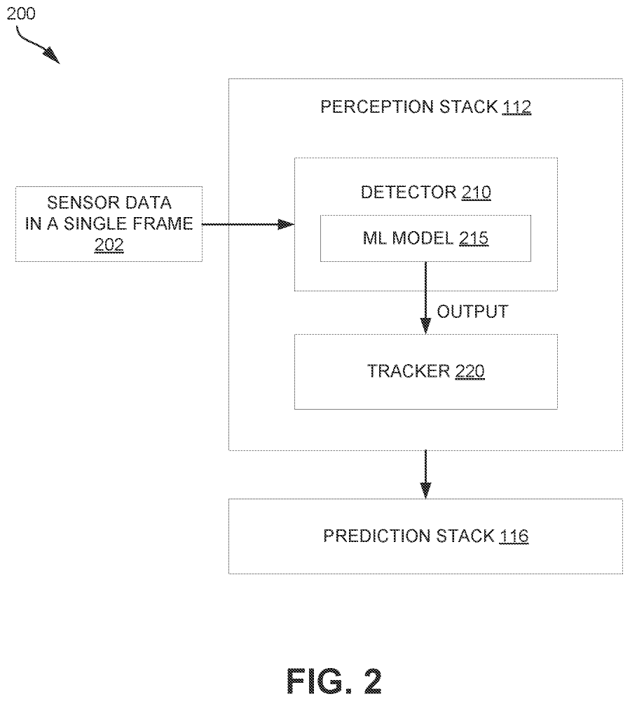

FIG. 2 illustrates an example system 200 for predicting a movability of an unclassified object. As shown, system 200 may comprise a perception stack 112 and a prediction stack 116. In some examples, detector 210 and tracker 220 can be implemented as part of perception stack 112.

The perception stack 112, as illustrated with respect to FIG. 1, may receive sensor data collected by one or more sensors of AV 102 (e.g., sensor systems 104-108 of AV 102) and detect an object that may be present around AV 102 in the scene. For example, detector 210 may access sensor data captured by various sensors of AV 102 and detect an object that is depicted in the sensor data. Also, tracker 220 of perception stack 112 can track the movement and trajectory of the object over time. As follows, AV 102 can predict the behavior of other road users and plan appropriate maneuvers. The prediction stack 116, as illustrated with respect to FIG. 1, may receive information about objects identified by perception stack 112 and predict a future path for the objects.

In some examples, detector 210 may receive sensor data and detect an object that is depicted in the sensor data. For example, detector 210 may receive sensor data 202 that is captured by an image sensor of AV 102 in a single frame (e.g., still image). That is, the sensor data 202 captured in a single frame does not have time-based information (or time series information) and does not include a motion signal. Non-limiting examples of a sensor that may capture sensor data 202 can include a camera sensor, a LIDAR sensor, an infrared sensor, a radar sensor, an ultrasonic sensor, radio triangulation arrays, and so on.

In some aspects, perception stack 112 may receive sensor data 202 in a single frame, which can include raw sensor data, in which the object depicted in the sensor data 202 is unclassified, unlabeled, and/or not within a bounding box.

In some approaches, detector 220 can consist of one or more machine-learning models that are trained to detect an object and predict a movability of the object in the sensor data 202 captured in a single frame. For example, ML model 215 included in detector 220 can be configured to detect an object in sensor data 202 within a single frame and determine whether the object (e.g., an unclassified and unlabeled object) may move in the scene.

In some instances, ML model 215 can take into account one or more contextual factors to determine movability of an object in the scene. For example, ML model 215 can consider, in determining the movability of the object, various contextual factors such as characteristics of the object (e.g., size, shape, dimension, etc.), road features or scene features (e.g., road geometry, lane geometry, traffic signs, curbs, sidewalks, other objects that are present in the scene, etc.), environmental elements (e.g., weather, etc.), and so on. For example, ML model 215 may determine the movability of an object in view of the object's dimension and/or estimated weight and the current wind speed in the scene.

In some examples, the output of ML model 215 can include a probability that the unclassified object may move in the scene. For example, ML model 215 can output a probability of the object's movability (e.g., from 0 to 1, from 0% to 100%, etc.). In some aspects, detector 210 may use the probability of the object's movability to determine whether the information associated with the object is to be provided to tracker 220 and/or prediction stack 116.

In some approaches, if detector 210 determines that the unclassified object may move in the scene (e.g., the probability is above a movability threshold), detector 210 may provide information associated with the movability of the unclassified object to tracker 220. As follows, tracker 220 may track the unclassified object in the scene.

In some aspects, if detector 210 determines that the unclassified object may move in the scene (e.g., the probability is above a movability threshold), detector 210 may provide information associated with the movability of the unclassified object to prediction stack 116. As follows, prediction stack 116 may predict a path of the unclassified object.

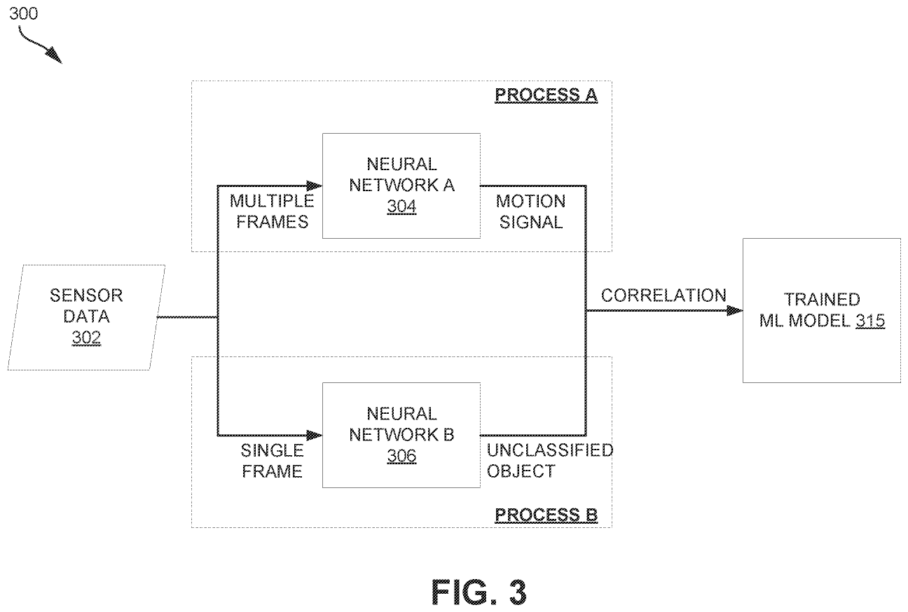

FIG. 3 is a diagram illustrating an example training pipeline 300 of training a neural network to predict a movability of an unclassified object. For example, ML model 215 as illustrated in FIG. 2 can be trained to predict the movability of the unclassified object in the scene in accordance with example pipeline 300. As shown, the training pipeline 300 can include two neutral networks, neural network A 304 and neural network B 306 that are fed with sensor data 302 to train trained ML model 315 (e.g., ML model 215 as illustrated in FIG. 2).

In some examples, training pipeline 300 can comprise process A, which includes providing multiple sensor data frames associated with an unclassified object to neural network A 304. For example, sensor data 302 may include multiple sensor data frames that are captured in a time series and depict an unclassified object in a scene. The neural network A 304 is configured to produce a motion signal of the unclassified object based on the sensor data with time-based information.

In some aspects, the motion signal can be determined based on background subtraction. For example, process A can include separating an unclassified object from a background in each of the multiple sensor data frames and determining the motion signal of the unclassified object based on the comparison between the background and foreground.

In some instances, training pipeline 300 can comprise process B, which includes providing a single sensor data frame associated with an unclassified object to neural network B 306. For example, sensor data 302 may include a single sensor data frame that does not have time-based information and depicts an unclassified object in a scene.

In some cases, training pipeline 300 can include correlating the motion signal of the unclassified object, which is determined based on the multiple sensor data frames (e.g., output of neural network A 304 in process A) with the unclassified object in the sensor data captured within the single frame (e.g., output of neural network B 306 in process B).

In some examples, process A of neural network A 304 and process B of neural network B 306 can be performed in parallel. In other examples, process A of neural network A 304 and process B of neural network B 306 can be performed sequentially. For example, process A of neural network A 304 can be done (e.g., to learn a movability from time series data and/or to learn that an unclassified object is movable) and subsequently, process B of neural network B 306 can be performed.

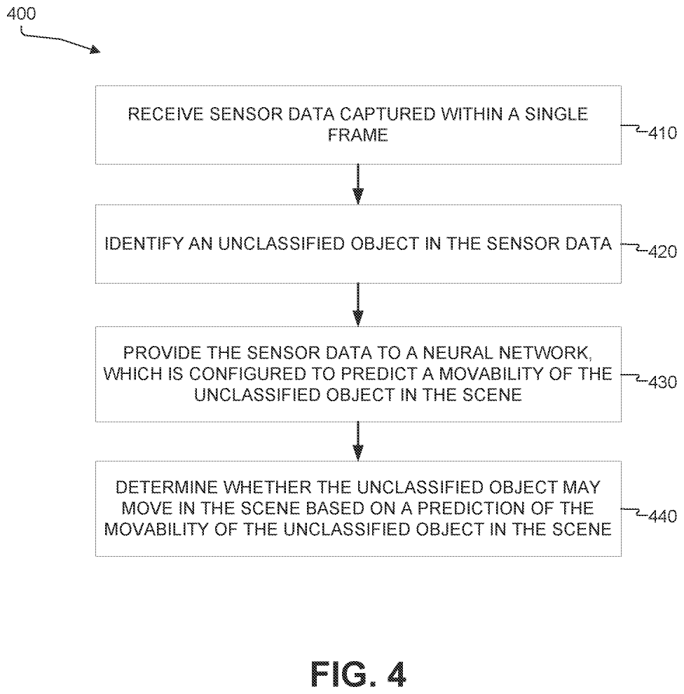

FIG. 4 is a flowchart illustrating an example process 400 for predicting a movability of an unclassified object. Although the example process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

At block 410, process 400 includes receiving sensor data captured within a single frame. The sensor data can be collected by one or more sensors of an autonomous vehicle in a scene. For example, detector 210 or perception stack 112 may receive sensor data 202 captured within a single frame. The sensor data 202 captured within the single frame can be collected by one or more sensors of AV 102 in a scene (e.g., sensor systems 104-108 of AV 102). For example, sensor data 202 may depict an object that is captured at a single frame and does not provide time-based information or motion-related information.

At block 420, process 400 includes identifying an unclassified object in the sensor data. For example, detector 210 or perception stack 112 can identify an unclassified object in sensor data 202 captured within a single frame. In some examples, sensor data 202 captured within a single frame may depict an unclassified object that may be an unusual or unconventional object such that a list of classification categories may not have a specific class for the unclassified object. For example, a bicycle bar (also referred to as a pedal pub, bar bike, etc.) that has pedals with people sitting around a bar table with a keg may not be able to fit into a specific category or has a high likelihood of misclassification.

At block 430, process 400 includes providing the sensor data to a neural network, which is configured to predict a movability of the unclassified object in the scene. For example, detector 210 or perception stack 112 may provide the sensor data captured within a single frame 202 to ML model 215 (or trained ML model 315), which is configured to predict a movability of the unclassified object in the scene. As previously described, a neural network, which is configured to predict a movability of an unclassified object is trained to learn that an unclassified object can move.

At block 440, process 400 includes determining whether the unclassified object may move or not in the scene based on the predicted movability of the unclassified object, which is output by the neural network. For example, detector 210 or perception stack 112 may determine whether the unclassified object may move or may not move based on the movability of the unclassified object that is output by ML model 215 (or trained ML model 315).

In response to a determination that the unclassified object may move in the scene, detector 210 may provide information associated with the unclassified object to tracker 220 and/or prediction stack 220 for tracking and/or predicting a path of the unclassified object.

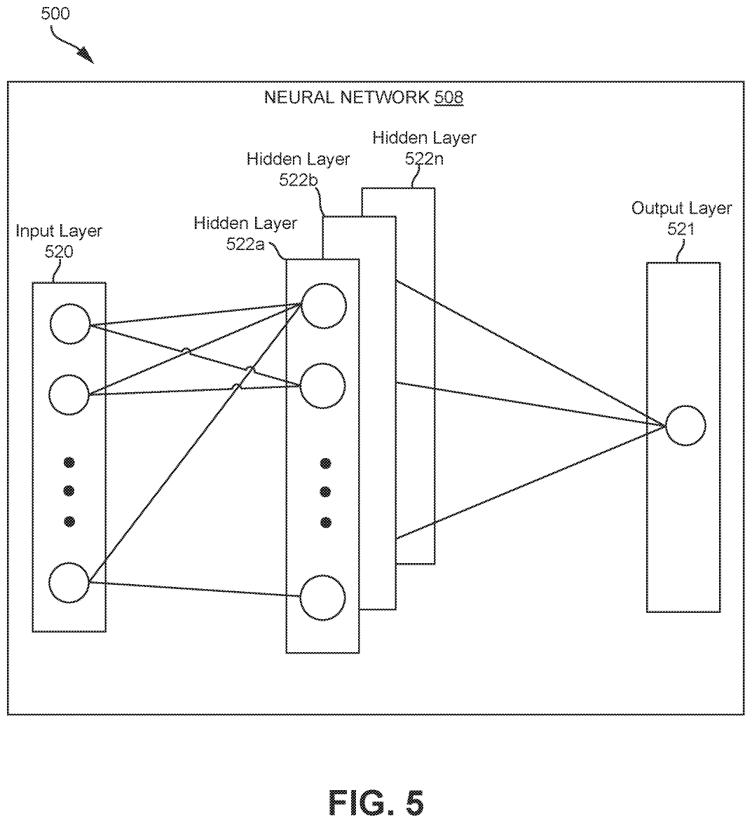

FIG. 5 illustrates an example neural network 508 that can be used to implement all or a portion of the systems and techniques described herein (e.g., neural network 500 can be used to implement a perception stack (or a perception system) such as detector 210, as discussed above). The example neural network 500 is merely one illustrative example provided for clarity and explanation purposes. One of ordinary skill in the art will recognize that other configurations of a neural network are also possible and contemplated herein.

An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

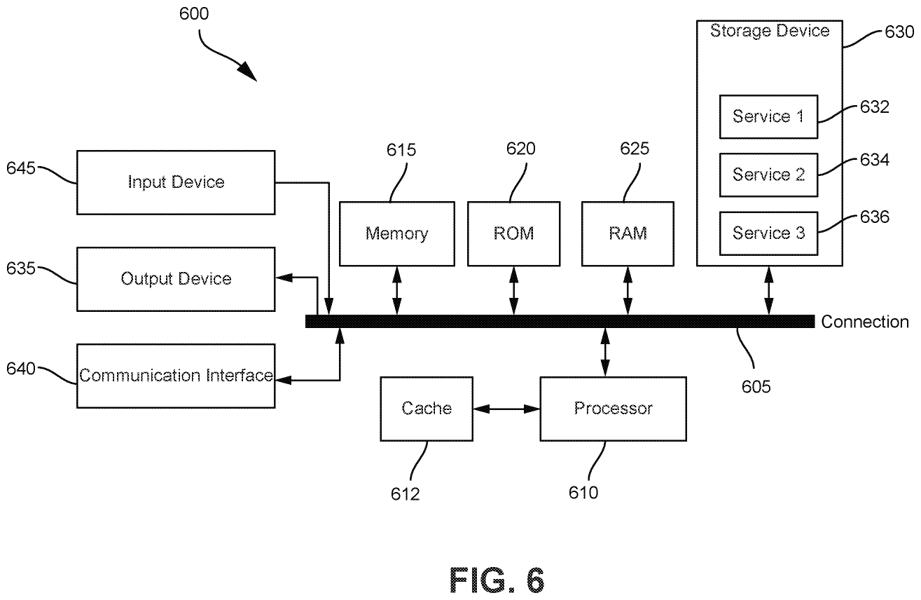

FIG. 6 illustrates an example processor-based system with which some aspects of the subject technology can be implemented. For example, processor-based system 600 can be any computing device making up local computing device 110, client computing device 170, a passenger device executing the ride-hailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some examples, a hardware service that performs a particular function can include the software component stored in a computer-readable medium in connection with the necessary hardware components, such as processor 610, connection 605, output device 635, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: receive sensor data captured within a single frame, wherein the sensor data is collected by one or more sensors of an autonomous vehicle in a scene; identify an unclassified object in the sensor data; provide the sensor data to a neural network, wherein the neural network is configured to predict a movability of the unclassified object in the scene; and determine whether the unclassified object may move in the scene based on a prediction of the movability of the unclassified object in the scene.

Aspect 2. The system of Aspect 1, wherein the prediction of the movability of the neural network comprises a probability that the unclassified object moves in the scene.

Aspect 3. The system of Aspects 1 or 2, wherein the one or more processors are configured to: in response to determining that the unclassified object may move in the scene, provide information associated with the movability of the unclassified object to a tracker, which is configured to track a path of the unclassified object in the scene.

Aspect 4. The system of any of Aspects 1 to 3, wherein the one or more processors are configured to: in response to determining that the unclassified object may move in the scene, provide information associated with the movability of the unclassified object to a prediction stack, which is configured to predict a path of the unclassified object.

Aspect 5. The system of any of Aspects 1 to 4, wherein the one or more processors are configured to: train the neural network to predict the movability of the unclassified object in the scene, wherein the training of the neural network comprises: providing multiple sensor data frames associated with the unclassified object, wherein the multiple sensor data frames are captured in a time series.

Aspect 6. The system of Aspect 5, wherein the training of the neural network comprises: separating the unclassified object from a background in each of the multiple sensor data frames; and determining the movability of the unclassified object based on the separation of the unclassified object in the multiple sensor data frames.

Aspect 7. The system of Aspect 5, wherein the training of the neural network comprises: correlating a motion signal of the unclassified object, which is determined based on the multiple sensor data frames with the unclassified object in the sensor data captured within the single frame.

Aspect 8. A method comprising: receiving sensor data captured within a single frame, wherein the sensor data is collected by one or more sensors of an autonomous vehicle in a scene; identifying an unclassified object in the sensor data; providing the sensor data to a neural network, wherein the neural network is configured to predict a movability of the unclassified object in the scene; and determining whether the unclassified object may move in the scene based on a prediction of the movability of the unclassified object in the scene.

Aspect 9. The method of Aspect 8, wherein the prediction of the movability of the neural network comprises a probability that the unclassified object moves in the scene. ‘

Aspect 10. The method of Aspects 8 or 9, further comprising: in response to determining that the unclassified object may move in the scene, provide information associated with the movability of the unclassified object to a tracker, which is configured to track a path of the unclassified object in the scene.

Aspect 11. The method of any of Aspects 8 to 10, further comprising: in response to determining that the unclassified object may move in the scene, provide information associated with the movability of the unclassified object to a prediction stack, which is configured to predict a path of the unclassified object.

Aspect 12. The method of any of Aspects 8 to 11, further comprising: train the neural network to predict the movability of the unclassified object in the scene, wherein the training of the neural network comprises: providing multiple sensor data frames associated with the unclassified object, wherein the multiple sensor data frames are captured in a time series.

Aspect 13. The method of Aspect 12, wherein the training of the neural network comprises: separating the unclassified object from a background in each of the multiple sensor data frames; and determining the movability of the unclassified object based on the separation of the unclassified object in the multiple sensor data frames.

Aspect 14. The method of Aspect 12, wherein the training of the neural network comprises: correlating a motion signal of the unclassified object, which is determined based on the multiple sensor data frames with the unclassified object in the sensor data captured within the single frame.

Aspect 15. A non-transitory computer-readable medium comprising instructions which, when executed by one or more processors, cause the one or more processors to perform a method according to any of Aspects 8 to 14.

Aspect 16. A system comprising means for performing a method according to any of Aspects 8 to 14.

Aspect 17. The system of Aspect 16, wherein the system comprises an autonomous vehicle.

Aspect 18. A computer-program product including instructions which, when executed by one or more processors, cause the one or more processors to perform a method according to any of Aspects 8 to 14.

What is claimed is:

1. A system comprising:
a memory; and
one or more processors coupled to the memory, the one or more processors being configured to:
receive sensor data captured within a single frame, wherein the sensor data is collected by one or more sensors of an autonomous vehicle in a scene;
identify an unclassified object in the sensor data;
provide the sensor data to a neural network, wherein the neural network is configured to predict a movability of the unclassified object in the scene; and
determine whether the unclassified object may move in the scene based on a prediction of the movability of the unclassified object in the scene.

2. The system of claim 1, wherein the prediction of the movability of the neural network comprises a probability that the unclassified object moves in the scene.

3. The system of claim 1, wherein the one or more processors are configured to:
in response to determining that the unclassified object may move in the scene, provide information associated with the movability of the unclassified object to a tracker, which is configured to track a path of the unclassified object in the scene.

4. The system of claim 1, wherein the one or more processors are configured to:
in response to determining that the unclassified object may move in the scene, provide information associated with the movability of the unclassified object to a prediction stack, which is configured to predict a path of the unclassified object.

5. The system of claim 1, wherein the one or more processors are configured to:
train the neural network to predict the movability of the unclassified object in the scene, wherein the training of the neural network comprises:
providing multiple sensor data frames associated with the unclassified object, wherein the multiple sensor data frames are captured in a time series.

6. The system of claim 5, wherein the training of the neural network comprises:
separating the unclassified object from a background in each of the multiple sensor data frames; and
determining the movability of the unclassified object based on the separation of the unclassified object in the multiple sensor data frames.

7. The system of claim 5, wherein the training of the neural network comprises:
correlating a motion signal of the unclassified object, which is determined based on the multiple sensor data frames with the unclassified object in the sensor data captured within the single frame.

8. A method comprising:
receiving sensor data captured within a single frame, wherein the sensor data is collected by one or more sensors of an autonomous vehicle in a scene;
identifying an unclassified object in the sensor data;
providing the sensor data to a neural network, wherein the neural network is configured to predict a movability of the unclassified object in the scene; and
determining whether the unclassified object may move in the scene based on a prediction of the movability of the unclassified object in the scene.

9. The method of claim 8, wherein the prediction of the movability of the neural network comprises a probability that the unclassified object moves in the scene.

10. The method of claim 8, further comprising:
in response to determining that the unclassified object may move in the scene, provide information associated with the movability of the unclassified object to a tracker, which is configured to track a path of the unclassified object in the scene.

11. The method of claim 8, further comprising:
in response to determining that the unclassified object may move in the scene, provide information associated with the movability of the unclassified object to a prediction stack, which is configured to predict a path of the unclassified object.

12. The method of claim 8, further comprising:
train the neural network to predict the movability of the unclassified object in the scene, wherein the training of the neural network comprises:
providing multiple sensor data frames associated with the unclassified object, wherein the multiple sensor data frames are captured in a time series.

13. The method of claim 12, wherein the training of the neural network comprises:
separating the unclassified object from a background in each of the multiple sensor data frames; and
determining the movability of the unclassified object based on the separation of the unclassified object in the multiple sensor data frames.

14. The method of claim 12, wherein the training of the neural network comprises:
correlating a motion signal of the unclassified object, which is determined based on the multiple sensor data frames with the unclassified object in the sensor data captured within the single frame.

15. A non-transitory computer-readable medium comprising instructions which, when executed by one or more processors, cause the one or more processors to:
receive sensor data captured within a single frame, wherein the sensor data is collected by one or more sensors of an autonomous vehicle in a scene;
identify an unclassified object in the sensor data;
provide the sensor data to a neural network, wherein the neural network is configured to predict a movability of the unclassified object in the scene; and
determine whether the unclassified object may move in the scene based on a prediction of the movability of the unclassified object in the scene.

16. The non-transitory computer-readable medium of claim 15, wherein the prediction of the movability of the neural network comprises a probability that the unclassified object moves in the scene.

17. The non-transitory computer-readable medium of claim 15, wherein the one or more processors are configured to:
in response to determining that the unclassified object may move in the scene, provide information associated with the movability of the unclassified object to a tracker, which is configured to track a path of the unclassified object in the scene.

18. The non-transitory computer-readable medium of claim 15, wherein the one or more processors are configured to:
in response to determining that the unclassified object may move in the scene, provide information associated with the movability of the unclassified object to a prediction stack, which is configured to predict a path of the unclassified object.

19. The non-transitory computer-readable medium of claim 15, wherein the one or more processors are configured to:
train the neural network to predict the movability of the unclassified object in the scene, wherein the training of the neural network comprises:
providing multiple sensor data frames associated with the unclassified object, wherein the multiple sensor data frames are captured in a time series.

20. The non-transitory computer-readable medium of claim 19, wherein the training of the neural network comprises:
separating the unclassified object from a background in each of the multiple sensor data frames; and
determining the movability of the unclassified object based on the separation of the unclassified object in the multiple sensor data frames.
